(19) United States
(12) Patent Application Publication
(10) Pub. No.: US 2022/0219493 A1
(43) Pub. Date: Jul. 14, 2022

(54) SENSOR SYSTEM FOR VEHICLE TIRES AND VEHICLE TIRES

(71) Applicant: Continental Reifen Deutschland GmbH, Hannover (DE)

(72) Inventors: Hans-Jürgen Sauerwald, Winterberg (DE); Mathias Sauerwald, Hannover (DE)

(73) Assignee: Continental Reifen Deutschland GmbH, Hannover (DE)

(21) Appl. No.: 17/594,852

(22) PCT Filed: Mar. 26, 2020
(86) PCT No.: PCT/EP2020/058582

§ 371 Date: Nov. 1, 2021

(30) Foreign Application Priority Data
May 2, 2019 (DE) 102019206265.2

(51) Int. Cl. B60C 11/24; B60C 19/00; B60C 23/20

(52) U.S. Cl. CPC B60C 11/243; B60C 2019/004; B60C 23/20; B60C 19/00

(57) ABSTRACT

A sensor system (10) for a vehicle tire (1) having at least one sensor (11, 12) and at least one control unit (13), wherein the sensor (11, 12) is electrically connected to the control unit (13) by means of at least one conductor track made of an electrically conductive elastomer.

The present invention relates to a sensor system for a vehicle tire. It also relates to a vehicle tire, in particular a solid rubber tire, having such a sensor system.

WO 2018/077502 A1 discloses the practice of using sensor elements in solid rubber tires. The problem here is the connection between the individual sensor element and a control unit assigned to the sensor element, for example a microcontroller.

This connection is typically made via wires or metallic conductor tracks. However, these are exposed to strong deformation forces, especially in solid rubber tires, and can therefore tear under long-term stress. This is particularly critical when the sensor element is not intended to be arranged in the area of the rim and thus in the vicinity of the control unit, but rather further outside in the tire.

It is an object of the present invention to specify a sensor system for a vehicle tire which does not have this disadvantage, but is constructed in a particularly robust manner and is therefore also suitable for monitoring the wear and tear on solid rubber tires.

This object is achieved with the subject matter of patent claim 1. The dependent claims relate to advantageous embodiments and developments.

One aspect of the invention specifies a sensor system for a vehicle tire having at least one sensor and at least one control unit, wherein the sensor is electrically connected to the control unit by means of at least one conductor track made of an electrically conductive elastomer.

Here and in the following, an electrically conductive elastomer is understood as meaning an elastomer which has an electrical resistivity of less than 1000 Ωm or even less than 100 Ωm. Such elastomers are sometimes also referred to as “conductive rubber” and can be produced, for example, by using conductive particles as fillers.

Thus, according to the invention, an electrically conductive elastomer takes over the electrical connection between the sensor and the control unit. This has the advantage—in particular compared to metallic conductor tracks only embedded in an elastomer—that the entire electrical connection between the sensor and the control unit is sufficiently elastic to take part in deformations of the tire. The electrical connection is therefore permanently stable. As has been found, the electrical conductivity of electrically conductive elastomer is sufficient to transmit sensor signals to the control unit.

In one embodiment, the at least one sensor is in the form of a temperature sensor. Such a temperature sensor can be arranged, in particular, in an intermediate layer which is located in the center of the tire and in which the energy introduced by tire deformation is converted into heat. An observation of the temperature profile in the intermediate layer allows conclusions to be drawn about the condition of the intermediate layer and its damage.

Any damage that has occurred or the preceding increase in temperature, which can even lead to liquefaction of the material, is generally not visible from the outside, since the outside of the tire hardly heats up due to the low thermal conductivity of the rubber. In order to be able to correctly record the tire temperature inside, an integrated temperature sensor in the middle of the intermediate layer is advantageous.

According to one embodiment, the at least one sensor is in the form of a wear sensor and has areas which form areas of a tread of a vehicle tire and are exposed to wear during operation.

For example, the wear sensor may be in the form of a resistive sensor and may have a number of current paths which are connected in parallel and can be arranged at different distances from a tread of the vehicle tire.

In this case, the number of current paths connected in parallel is reduced with increasing wear, with the result that the electrical resistance of the sensor changes.

Alternatively, the wear sensor may be in the form of a capacitive sensor and may have at least one first electrode made of an electrically conductive elastomer, at least one second electrode made of an electrically conductive elastomer, and at least one dielectric layer which is made of a further, electrically insulating elastomer and is arranged between the electrodes, wherein the electrodes and the layer can be arranged perpendicular to a tread of the vehicle tire.

In this embodiment, the area of the electrodes is reduced with increasing wear of the vehicle tire, with the result that the capacitance of the capacitor formed from the electrodes and the electrical layer changes. Such a wear sensor can be used to quantify the wear of a solid rubber tire in a particularly simple manner.

One aspect specifies a vehicle tire having the described sensor system, wherein the vehicle tire is in the form of a solid rubber tire, in particular. For example, it can be a tire for a floor conveyor or a similar work machine.

The “intelligent” vehicle tire equipped with the sensor system has the advantage that the sensor system allows precise monitoring of the condition of the vehicle tires, wherein electrical connections are particularly robust at the same time and the vehicle tire having the sensor system is thus particularly resilient and has a long service life.

The sensor of the sensor system can be arranged in a layer of the vehicle tire, depending on the type of sensor. For example, a temperature sensor can be advantageously arranged in an intermediate layer of the tire, while a wear sensor can be advantageously arranged in the area of a tread of the vehicle tire.

The sensor system is arranged, in particular, in a hole in the vehicle tire.

A further aspect of the invention specifies a wheel system having the described vehicle tire, which wheel system also comprises a rim in addition to the vehicle tire. In this case, the control unit of the sensor system is arranged on a rim of the wheel system. Alternatively, it is also conceivable to arrange the control unit in the vehicle tire.

Embodiments are explained in more detail below with reference to the schematic figures.

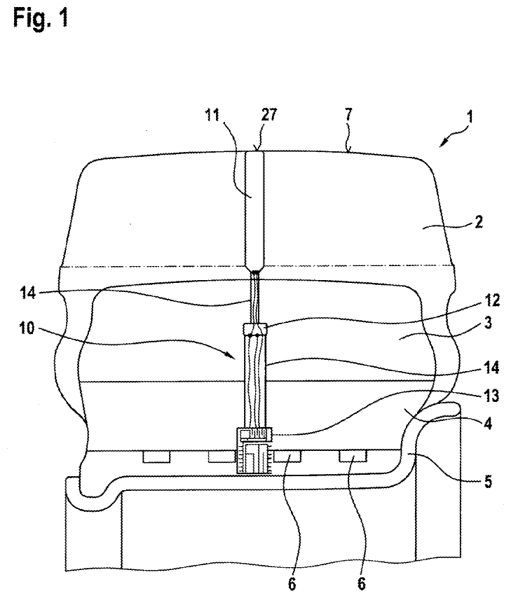

FIG. 1 shows a section through a solid rubber tire having a sensor system according to one embodiment of the invention;

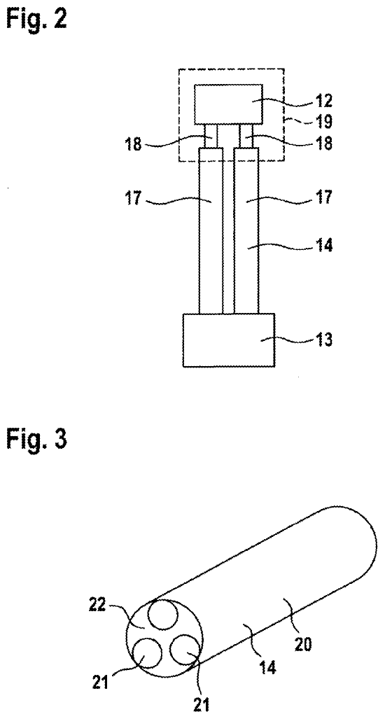

FIG. 2 shows a sensor in the form of a temperature sensor according to one embodiment of the invention;

FIG. 3 shows a connector for establishing an electrical connection between the sensor and the control unit according to one embodiment of the invention;

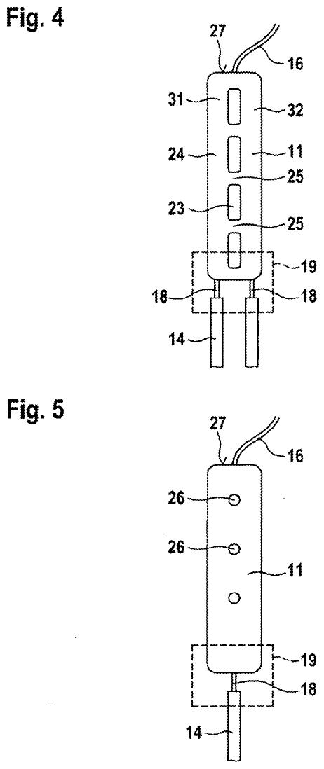

FIG. 4 shows a longitudinal section view of a sensor in the form of a wear sensor according to a first embodiment of the invention;

FIG. 5 shows a side view of the sensor according to FIG. 4, and

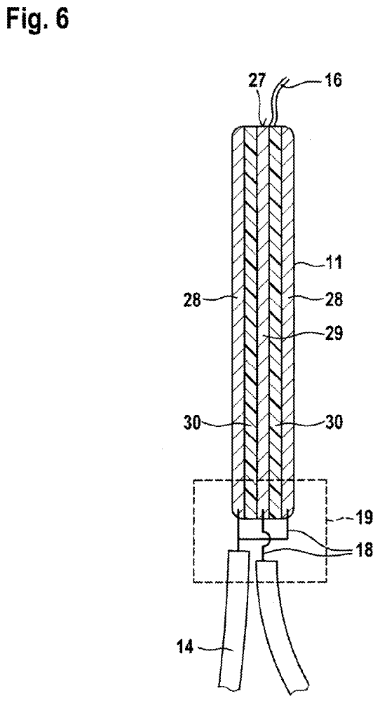

FIG. 6 shows a sectional view of a sensor in the form of a wear sensor according to a second embodiment of the invention.

FIG. 1 shows a vehicle tire 1 which is in the form of a solid rubber tire and is arranged on a rim 5 of a wheel system. The vehicle tire 1 has various elastomer layers. However, use in a pneumatic tire is also conceivable. In a known manner, the elastomer layers form a bottom layer 4 with steel reinforcements 6, an intermediate layer 3 and a running layer 2, each of which has different properties. In particular, the intermediate layer 3 is designed to be relatively elastic in order to minimize the rolling resistance and thus to reduce the generation of heat.

The vehicle tire 1 has, in a hole (not illustrated), a sensor system 10 having a first sensor 11 and a second sensor 12 as well as a control unit 13 which is in the form of a microcontroller in the embodiment shown and is arranged or fastened in the area of the rim 5, for example in a molded-in pocket.

The sensor 11 is arranged in the running layer 2 and is in the form of a wear sensor. An area 27 of the sensor 11 forms a small area of a tread 7 of the vehicle tire 1 and, like this, is exposed to wear during operation. The sensor 11 is connected to the control unit 13 via electrical connections 14 made of electrically conductive elastomers.

The second sensor 12 is arranged in the intermediate layer 3 and is in the form of a temperature sensor. It also has a connection 14 made of an electrically conductive elastomer to the control unit 13.

FIG. 2 shows the sensor 12 in the form of a temperature sensor. As can be seen in this illustration, the sensor 12 has two contact connections 18. It is also conceivable for the sensor 12 to have more contact connections 18. In the present embodiment, however, a sensor 12 was used, the signals from which can be advantageously tapped off via its supply line, with the result that only two contact connections 18 are required. The connections 18 are electrically connected to the control unit 13 by means of the connection 14. In the embodiment shown in FIG. 2, the connection 14 is made up of individual connectors 17, wherein one connector 14 makes contact with one contact connection 18 in each case.

FIG. 3 shows an alternative embodiment in which the connection has only a single connector 20 which is constructed from individual conductor tracks 21 made of electrically conductive elastomer in an electrically insulating matrix 22. For example, the matrix 22 can be produced as an extruded profile from an insulating elastomer and the grooves can be filled with electrically conductive elastomer.

The connection 14 does not have any metallic wires or conductor tracks, but rather is composed entirely of electrically conductive elastomer and possibly additionally (in particular as sheathing) electrically insulating elastomer. It therefore forms a conductor track made of an electrically conductive elastomer. It is therefore designed to be at least as flexible as the layers of the vehicle tire surrounding it. This prevents electrical connections from breaking.

The connections 14 made of electrically conductive elastomer typically have diameters of a few millimeters, for example approximately 2 mm. As has been found, the sensor signals can thus be transmitted satisfactorily.

The dashed line 19 in FIGS. 2, 4, 5 and 6 indicates an encapsulation of the sensor 11, 12 and its contact connections 18 by means of a potting compound which can be provided for the purpose of protecting the electrical contact connections 18, in particular.

FIG. 4 shows an embodiment of the first sensor 11 which is in the form of a resistive wear sensor. According to this embodiment, the sensor 11 has two different elastomers, namely an insulator 23 and an electrical conductor 24. In this case, the insulator 23 forms a layer which is interrupted in places between two layers of the electrical conductor 24. Contact is made with each layer of the electrical conductor 24 by means of a contact connection 18. The two electrically conductive layers 31, 32 are connected to one another by means of connections 25 made of the electrically conductive elastomer. The connections 25 are in the form of openings in the layer of the insulator 23.

In the side view according to FIG. 5, it can be seen that the connections 25 were produced by making individual holes 26 in a sandwich structure comprising a layer 31 of the conductor 24, a layer of the insulator 23 and a layer 32 of the conductor 24 and filling them with the conductor 24. The sandwich structure made of two different elastomers can be produced, for example, by means of a triplex extruder.

The connections 25 form areas of current paths which lead from one contact connection 18 to the other contact connection 18. With increasing wear of the vehicle tire 1, into which the sensor 11 is drawn, for example with the aid of a cord 16, some of the connections 25 are removed. This changes the electrical resistance of the sensor.

FIG. 6 shows an alternative embodiment of a sensor 11 which is also in the form of a wear sensor, but is in the form of a capacitive wear sensor. In this embodiment, the sensor 11 has a layer structure comprising three electrically conductive layers and two electrically insulating layers arranged in between in each case, which can be produced, in particular, by means of an extrusion process. In this case, two outer electrically conductive layers form a first electrode 28, while the inner electrically conductive layer forms a second electrode 29 and the insulating material arranged in between forms a dielectric layer 30.

Overall, the sensor 11 thus forms a capacitor with an area which decreases with increasing wear of the vehicle tire and therefore also of the sensor 11, wherein both the electrode area and the area of the dielectric layer 30 decrease in the embodiment shown. This also reduces the capacitance of the sensor 11, which is proportional to the electrode area. The capacitance is evaluated by means of the control unit 13 in order to determine the mileage or the wear of the vehicle tire 1.

The electrodes 28, 29 and the dielectric 30 are arranged in this case perpendicular to the tread 7 of the vehicle tire 1 in order to ensure that the capacitor area is reduced with increasing wear.

The vehicle tire 1 in FIG. 1 has both a (resistive or capacitive) wear sensor 11 and a temperature sensor 12 as well as a control unit 13 which receives signals from both sensors 11, 12 and is connected to both via conductor tracks made of electrically conductive elastomer. It is also conceivable to provide only one of the two sensors 11, 12 or a control unit 13 for each of the sensors 11, 12.

As has been found, the sensor 11 also reacts to deformations. This makes it possible to also infer the load, the speed and the distance covered from the sensor signal.

### LIST OF REFERENCE SIGNS

1 Vehicle tire
2 Running layer
3 Intermediate layer
4 Bottom layer
5 Rim
6 Steel reinforcement
7 Tread
10 Sensor system
11 Sensor
12 Sensor
13 Control unit
14 Connection
16 Cord
17 Connector
18 Contact connection
19 Dashed line
20 Connector
21 Conductor track
22 Matrix
23 Insulator
24 Conductor
25 Connection
26 Hole
27 Area
28 First electrode
29 Second electrode
30 Dielectric layer
31 Layer
32 Layer

1.-8. (canceled)

9. A sensor system for a vehicle tire comprising at least one sensor and at least one control unit, wherein the sensor is electrically connected to the control unit by means of at least one conductor track made of an electrically conductive elastomer.

10. The sensor system as claimed in claim 9, wherein the at least one sensor is in the form of a temperature sensor.

11. The sensor system as claimed in claim 9, wherein the at least one sensor is in the form of a wear sensor and has sensor areas which form areas of a tread of a vehicle tire and are exposed to wear during operation.

12. The sensor system as claimed in claim 11, wherein the wear sensor is in the form of a resistive sensor and has a number of current paths which are connected in parallel and can be arranged at different distances from a tread of the vehicle tire.

13. The sensor system as claimed in claim 11, wherein the wear sensor is in the form of a capacitive sensor and has the following:
at least one first electrode made of an electrically conductive elastomer,
at least one second electrode made of an electrically conductive elastomer,
at least one dielectric layer which is made of a further elastomer and is arranged between the electrodes,
wherein the electrodes and the dielectric layer can be arranged perpendicular to a tread of the vehicle tire.

14. A vehicle tire comprising a sensor system as claimed in claim 9.

15. The vehicle tire as claimed in claim 14, wherein the sensor system is arranged in a hole in the vehicle tire.

16. A wheel system comprising a vehicle tire as claimed in claim 14, wherein the control unit of the sensor system is arranged on a rim of the wheel system.

17. A sensor system for a vehicle tire comprising:
at least one sensor comprising a temperature sensor and a wear sensor, the wear sensor formed in areas of a tread of a vehicle tire and are exposed to wear during operation; and
at least one control unit; and
the sensor is electrically connected to the control unit by at least one conductor track comprising an electrically conductive elastomer.

18. The sensor system as claimed in claim 17, the wear sensor is a resistive sensor and has a plurality of current paths connected in parallel and arranged at different distances from the tread of the vehicle tire.

19. The sensor system as claimed in claim 17, wherein the wear sensor is a capacitive sensor and has the following:
at least one first electrode made of an electrically conductive elastomer,
at least one second electrode made of an electrically conductive elastomer,
at least one dielectric layer which is made of a further elastomer and is arranged between the electrodes,
wherein the electrodes and the dielectric layer can be arranged perpendicular to a tread of the vehicle tire.

20. The sensor system as claimed in claim 17, the control unit configured to receive a temperature signal from the temperature sensor and a wear signal from the wear sensor by the electrically conductive elastomer of the at least one conductive track.

21. The sensor system as claimed in claim 20, the wear sensor configured to react to deformations.

22. The sensor system as claimed in claim 21, the control unit configured to infer a load, a speed and a distance covered based on the wear signal from the wear sensor.

23. The sensor system as claimed in claim 22, the wear sensor located within a running layer of the tire and having a tread portion as part of the tread, the wear sensor comprising a plurality of insulator elastomers and a plurality of electrical conductor elastomers arranged to vary resistance based on wear.

24. The sensor system as claimed in claim 23, the temperature sensor positioned below the wear sensor and the control unit formed in a molded-in pocket of a bottom layer adjacent a rim, the control unit in the form of a microcontroller.

25. The sensor system as claimed in claim 17, the tire comprising a bottom layer adjacent a rim, an intermediate layer formed on the bottom layer and a running layer formed on the intermediate layer and having the tread on an outer surface.

26. The sensor system as claimed in claim 25, the wear sensor positioned in the running layer, the temperature sensor at least partially formed in the intermediate layer and the control unit formed in the bottom layer, the intermediate layer configured to minimize rolling resistance and reduce generation of heat.
